(19) United States
(12) Patent Application Publication
(10) Pub. No.: US 2009/0204899 A1
(43) Pub. Date: Aug. 13, 2009

(54) MOBILE JOURNAL FOR PORTABLE ELECTRONIC EQUIPMENT

(75) Inventor: Daniel L. Bennett, Raleigh, NC (US)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/028,043

(22) Filed: Feb. 8, 2008

(51) Int. Cl. G06F 3/048

(52) U.S. Cl. 715/730

(57) ABSTRACT

A method, device and computer program for gathering event information associated with use, location, environment and/or function performed by a portable communication device. Event information may be stored in a memory of the portable communication device. The event information may include a date of the event, time event began, elapsed time of the event, event activity and location information associated with the event. The event information may then be sorted based upon a user defined criteria and presented on a display as a slide show. The slide show generally includes location information displayed in a map format along with event information including duration data displayed on the map for a user-specified time frame.

### TECHNICAL FIELD OF THE INVENTION

The present invention relates generally to electronic equipment and, more particularly, to electronic equipment and a method of generating a mobile journal that creates a log of event information associated with the use, location, environment and/or functions performed by the electronic equipment.

### DESCRIPTION OF THE RELATED ART

Conventional mobile telephones, in addition to providing voice communication capabilities, also provide a number of non-voice related features. For example, mobile telephones can be used to “surf” the internet, transmit and receive messages (e.g., emails and text messages (SMS)), play music and videos, take and display photographs, track location using GPS (or other means), as well as a number of other features. Many mobile telephones include other tools such as contact lists, calendars, alarm clocks, notepads, etc. Some mobile telephones also include a keyboard and a CPU that gives the phone personal computer-like functionality.

As a result of the increased functionality of mobile telephones, users are becoming more and more reliant on such devices. Indeed, for many people a mobile telephone is an essential part of their everyday life. For example, in a given day a phone alarm clock may wake a user in the morning and the phone calendar may remind the user of various tasks to be performed during the day. The user may then use the mobile telephone to place calls throughout the day to work associates and family members. Various text messages may be sent between the user and various acquaintances of the user. Throughout the course of the day the user may use the mobile telephone to read and/or respond to numerous E-mails. In the evening, the telephone might be used to take a picture or video of an interesting event that the user experiences.

Typical mobile telephones include individual application activity logs that record activities associated with a particular application. Accordingly, at the end of the day (or other relevant time period) the mobile telephone contains a substantial amount of information regarding events in the user's day including, for some applications, the time such event occurred and the duration of the event. Although the user may reference some of the information stored in the mobile telephone, most of the information currently is not easily available to the user in a central application. Accordingly, the information is difficult and time consuming to obtain, even if the information is obtainable. In addition, many applications delete such information after a period of time or when the respective logs are full. For the reasons set forth above, much of the information contained in the mobile telephone is erased rather than utilized by the user.

### SUMMARY

The present invention provides a method of generating a mobile journal based on use of the mobile telephone, location of the mobile telephone and/or environment of the mobile telephone. More particularly, the invention provides a method for generating a mobile journal, the method including: gathering event information associated with use of the portable communication device; storing the event information in memory, wherein the event information includes a timestamp of the event, wherein the timestamp includes fields corresponding to a date of the event, time event began, elapsed time of the event, event activity and location information associated with the event; sorting the information based upon a user defined criteria; and presenting the information on a display as a slide show, wherein the slide show includes location information displayed in a map format along with event information including duration data displayed on the map for a user-specified time frame.

Another aspect of the invention relates to event information including messages received by and transmitted from the portable communication device.

Another aspect of the invention relates to the event information including one or more photographs and/or videos taken from the portable communication device.

Another aspect of the invention relates to obtaining track identification information associated with music and/or video audible during creation of the one or more photographs and/or videos.

Another aspect of the invention relates to the event information includes audio files rendered by the portable communication device.

Another aspect of the invention relates to the event information including contact information, calendar information and/or schedule information stored in the memory of the portable communication device.

Another aspect of the invention relates to selecting event information to be included in the slide show, wherein the event information is selected based on one or more of the timestamp fields.

Another aspect of the invention relates to the slide show including graphical information regarding the location information associated with the selected event information.

Another aspect of the invention relates to the slide show further includes graphical information regarding event duration data.

Another aspect of the invention relates to rendering at least one audio file while presenting the slide show.

Another aspect of the invention relates to including downloading the slide show presentation to a computer for editing and/or presentation on the computer.

Another aspect of the invention relates to a portable communication device, the device including: a display for presenting information to an associated user; a memory for storing event information associated with use of the portable communication device, wherein the event information includes timestamp information that includes fields corresponding to a date event began, time event began, elapsed time of the event, event activity and location information associated with the use of the portable communication device; application software stored in the memory and configured to generate a multimedia presentation of the event information stored in the memory, wherein the multimedia presentation includes geographic data displayed on a map and event data including duration data displayed on the map for a user-specified time frame; and a controller coupled to the memory and responsive to the application software for presenting the multimedia presentation on the display as a slide show.

Another aspect of the invention relates to event information including messages received by and transmitted from the portable communication device.

Another aspect of the invention relates to event information including one or more photographs and/or videos taken from the portable communication device.

Another aspect of the invention relates to event information including music and/or video identification information audible when the one or more photographs and/or videos were created.

Another aspect of the invention relates to event information including audio files rendered by the portable communication device.

Another aspect of the invention relates to the slide show including graphical information regarding location information.

Another aspect of the invention relates to the slide show further includes graphical information regarding event duration data.

Another aspect of the invention relates to the device being a mobile telephone.

Another aspect of the invention relates to a computer program stored on a machine readable medium, the program being suitable for use in a portable communication device as a mobile journal application, wherein: when the program is loaded in memory in the portable communication device and executed causes the portable communication device to: gather event information associated with use of the portable communication device; store the event information in a memory of the portable communication device, wherein the event information includes a timestamp of the event, wherein the timestamp includes fields corresponding to a date of the event, time event began, elapsed time of the event, event activity and location information associated with the event; sort the information based upon a user defined criteria; and present the information on a display of the portable communication device as a slide show, wherein the slide show includes location information displayed in a map format along with event information including duration data displayed on the map for a user-specified time frame.

To the accomplishment of the foregoing and the related ends, the invention, then, comprises the features hereinafter fully described in the specification and particularly pointed out in the claims, the following description and the annexed drawings setting forth in detail certain illustrative embodiments of the invention, these being indicative, however, of but several of the various ways in which the principles of the invention may be suitably employed.

Other systems, methods, features, and advantages of the invention will be or become apparent to one with skill in the art upon examination of the following drawings and detailed description. It is intended that all such additional systems, methods, features, and advantages be included within this description, be within the scope of the present invention, and be protected by the accompanying claims.

Although the invention is shown and described with respect to one or more embodiments, it is to be understood that equivalents and modifications will occur to others skilled in the art upon the reading and understanding of the specification. The present invention includes all such equivalents and modifications, and is limited only by the scope of the claims.

Also, although the various features are described and are illustrated in respective drawings/embodiments, it will be appreciated that features of the given drawing or embodiment may be used in one or more other drawings or embodiments of the invention.

It should be emphasized that the term “comprise/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Likewise, elements and features depicted in one drawing may be combined with elements and features depicted in additional drawings. Moreover, in the drawings, like reference numerals designate corresponding parts throughout the several views.

FIG. 1 is an illustration of an exemplary mobile telephone in accordance with aspects of the present invention.

FIG. 2 is a schematic illustration of components of an exemplary mobile telephone in accordance with aspects of the present invention.

FIG. 3 is a block diagram of a memory architecture in accordance with aspects of the present invention.

FIG. 4 is an exemplary database in accordance with an embodiment of the invention.

FIGS. 5-10 are schematic illustration of a plurality of slides of a slideshow in accordance with an embodiment of the invention.

FIG. 11 is an exemplary method in accordance with aspects of the present invention.

### DETAILED DESCRIPTION OF EMBODIMENTS

The present invention will now be described with reference to the drawings, wherein like reference numerals are used to refer to like elements throughout.

The term “portable communication device” includes any portable electronic equipment including, for example, mobile radio terminals, mobile telephones, mobile devices, mobile terminals, communicators, pagers, electronic organizers, personal digital assistants, smartphones and the like. The term “portable communication device” also may include portable digital music players and/or video display devices, e.g., ipod devices, MP3 players, DVD players, etc.

In the present application, aspects of the invention are described primarily in the context of a mobile telephone. However, it will be appreciated that the invention is not intended to be limited to a mobile telephone and can be any type of electronic equipment. In general, aspects of the present invention relate to a portable communication device, method and computer program for gathering event information associated with use, location, environment and/or function performed by a portable communication device. Event information may be stored in a memory of the portable communication device. The event information includes a date of the event, time event began, elapsed time of the event, event activity and location information associated with the event. The event information may then be sorted based upon a user defined criteria and presented on a display as a slide show. The slide show generally includes location information displayed in a map format along with event information including duration data displayed on the map for a user-specified time frame. The representation of the various events may also be illustrated to indicate the elapsed time of an event. For example, large graphical representations indicate a longer time for the event than an event that has a smaller representation.

Aspects of the invention address the issue of allow a user to track his or her life and day to day activities through organizing and presenting information that is available on the user's mobile telephone in a chronological, event-based manner. In general, this invention gathers all of the information that a user has or processes through the user's phone and correlates it according to a date, activity, and position (if the phone is GPS enabled). Every piece of data that is gathered is stored with a timestamp for processing later chronologically. In addition to the timestamp, the application also utilizes “event length” (also referred to as elapsed time of an event) and location information so that the event information can later be used to create a true timeline of the user's experiences through the mobile telephone for a specified time period.

In everyone's busy schedule, it is common to think back over a week and try to remember what he or she did. Often times, it is difficult for the user to remember these events. This problem is aggravated when a person must recount events that transpired over a month or more. For example, a user may try to remember the circumstances around a photograph that was taken on vacation or during a night out with friends. A vast amount of information is already available on mobile telephones. Available information includes for example: pictures from high quality cameras; written conversations through SMS; locations can be collected through GPS receivers; calendars or schedules if the user inputs this information in his/or organizer, etc. In addition, music that was being played during events can be identified through software, such as track identification software.

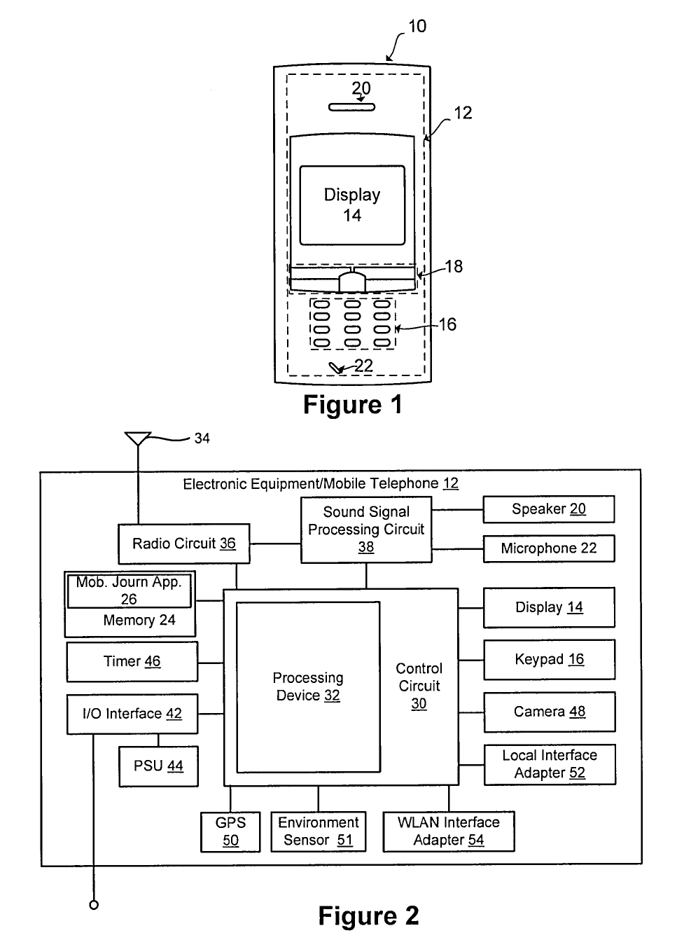

Referring to FIG. 1, an electronic equipment 10 is shown in accordance with the present invention. The electronic equipment 10 in the exemplary embodiment is a mobile telephone and will be referred to as the mobile telephone 10. The mobile telephone 10 is shown as having a “brick” or “block” design type housing, but it will be appreciated that other type housings, such as clamshell housing or a slide-type housing, may be utilized without departing from the scope of the invention.

As illustrated in FIG. 1, the mobile telephone 10 may include a user interface 12 (identified by dotted lines) that enables the user easily and efficiently to perform one or more communication tasks (e.g., send an E-mail, display an E-mail, receive an E-mail, identify a contact, select a contact, make a telephone call, receive a telephone call, etc). The user interface 12 of the mobile telephone 10 generally includes one or more of the following components: a display 14, an alphanumeric keypad 16, function keys 18, a navigation tool 19, a speaker 20, and a microphone 22.

The mobile telephone 10 includes a display 14. The display 14 displays information to a user such as operating state, time, telephone numbers, contact information, various navigational menus, status of one or more functions, etc., which enable the user to utilize the various features of the mobile telephone 10. The display 14 may also be used to visually display content accessible by the mobile telephone 10. The displayed content may include E-mail messages, geographical information, journal information, audio and/or video presentations stored locally in memory 24 (FIG. 2) of the mobile telephone 10 and/or stored remotely from the mobile telephone 10 (e.g., on a remote storage device, a mail server, remote personal computer, etc.). Such presentations may be derived, for example, from multimedia files received through E-mail messages, including audio and/or video files, from a received mobile radio and/or television signal, etc. The audio component may be broadcast to the user with a speaker 20 of the mobile telephone 10. Alternatively, the audio component may be broadcast to the user though a headset speaker (not shown).

The mobile telephone 10 further includes a keypad 16 that provides for a variety of user input operations. For example, the keypad 16 may include alphanumeric keys for allowing entry of alphanumeric information such as E-mail addresses, distribution lists, telephone numbers, phone lists, contact information, notes, etc. In addition, the keypad 16 typically may include special function keys such as a “call send” key for transmitting an E-mail, initiating or answering a call, and a “call end” key for ending, or “hanging up” a call. Special function keys may also include menu navigation keys, for example, for navigating through a menu displayed on the display 14 to select different telephone functions, profiles, settings, etc., as is conventional. Other keys associated with the mobile telephone 10 may include a volume key, audio mute key, an on/off power key, a web browser launch key, an E-mail application launch key, a camera key, etc. Keys or key-like functionality may also be embodied as a touch screen associated with the display 14.

The mobile telephone 10 includes conventional call circuitry that enables the mobile telephone 10 to establish a call, transmit and/or receive E-mail messages, and/or exchange signals with a called/calling device, typically another mobile telephone or landline telephone. However, the called/calling device need not be another telephone, but may be some other device such as an Internet web server, E-mail server, content providing server, etc.

Referring to FIG. 2, a functional block diagram of the mobile telephone 10 is illustrated. The mobile telephone 10 includes a primary control circuit 30 that is configured to carry out overall control of the functions and operations of the mobile telephone 10. The control circuit 30 may include a processing device 32, such as a CPU, microcontroller or microprocessor. The processing device 32 executes code stored in a memory (not shown) within the control circuit 30 and/or in a separate memory, such as memory 24, in order to carry out operation of the mobile telephone 10. The processing device 32 is generally operative to compare a file size of the E-mail message with a threshold file size and configures the mobile telephone for communication using the first mode or the second mode, as described below.

The memory 24 may be, for example, a buffer, a flash memory, a hard drive, a removable media, a volatile memory and/or a non-volatile memory. The memory 24 may also include mobile journal application software 26 that facilitates the collection of event information and creation of a slide show for a mobile journal, as discussed herein.

Continuing to refer to FIGS. 1 and 2, the mobile telephone 10 includes an antenna 34 coupled to a radio circuit 36. The radio circuit 36 includes a radio frequency transmitter and receiver for transmitting and receiving signals via the antenna 34 as is conventional. The mobile telephone 10 generally utilizes the radio circuit 36 and antenna 34 for voice and/or E-mail mail communications over a cellular telephone network. The mobile telephone 10 further includes a sound signal processing circuit 38 for processing the audio signal transmitted by/received from the radio circuit 36. Coupled to the sound processing circuit 38 are the speaker 20 and a microphone 22 that enable a user to listen and speak via the mobile telephone 10 as is conventional. The radio circuit 36 and sound processing circuit 38 are each coupled to the control circuit 30 so as to carry out overall operation.

The mobile telephone 10 also includes the aforementioned display 14 and keypad 16 coupled to the control circuit 30. The mobile telephone 10 further includes an I/O interface 42. The I/O interface 42 may be in the form of typical mobile telephone I/O interfaces, such as a multi-element connector at the base of the mobile telephone 10. As is typical, the I/O interface 42 may be used to couple the mobile telephone 10 to a battery charger to charge a power supply unit (PSU) 44 within the mobile telephone 10. In addition, or in the alternative, the I/O interface 42 may serve to connect the mobile telephone 10 to a wired personal hands-free adaptor, to a personal computer or other device via a data cable, etc. The mobile telephone 10 may also include a timer 46 for carrying out timing functions. Such functions may include timing the durations of calls and/or events, tracking elapsed times of calls and/or events, generating timestamp information, e.g., date and time stamps, etc.

The mobile telephone 10 may include various built-in accessories, such as a camera 48 for taking digital pictures. Image files corresponding to the pictures may be stored in the memory 24. In one embodiment, the mobile telephone 10 also may include a position data receiver 50, such as a global positioning satellite (GPS) receiver, Galileo satellite system receiver or the like. The mobile telephone 10 may also include an environment sensor 51 to measure conditions (e.g., temperature, barometric pressure, humidity, etc.) in which the mobile telephone is exposed.

The mobile telephone 10 may include a local wireless interface adapter 52, such as a Bluetooth adaptor to establish wireless communication with other locally positioned devices, such as the a wireless headset, another mobile telephone, a computer, etc. In addition, the mobile telephone 10 may also include a wireless local area network interface adapter 54 to establish wireless communication with other locally positioned devices, such as a wireless local area network, wireless access point and the like. Preferably, the WLAN adapter 54 is compatible with one or more IEEE 802.11 protocols (e.g., 802.11 (a), 802.11 (b) and/or 802.11 (g), etc.) and allows the mobile telephone 10 to acquire a unique address (e.g., IP address) on the WLAN and communicate with one or more devices on the WLAN, assuming the user has the appropriate privileges and/or has been properly authenticated.

As shown in FIG. 2, the processing device 32 is coupled to memory 24. Memory 24 stores a variety of data including mobile journal application software 26 that is used by the processor 32 to generate a mobile journal in accordance with aspects of the present invention. It will be appreciated that data can be stored in other additional memory banks (not illustrated) and that the memory banks can be of any suitable types, such as read-only memory, read-write memory, etc.

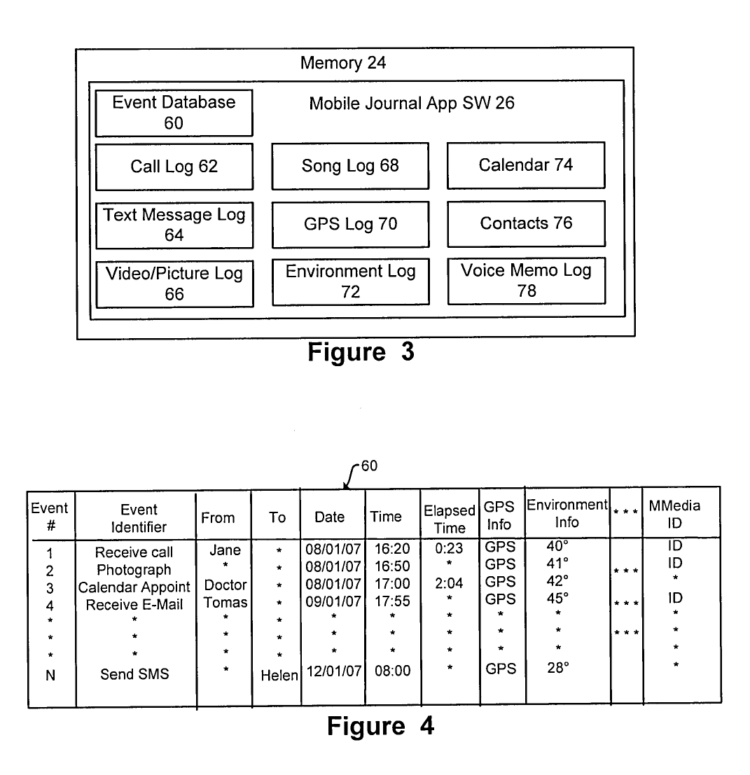

Memory 24 may store a variety of data associated with the mobile journal application software 26. Generally, any and all information based on the use and/or geographical location of the mobile telephone may be stored in the memory 24 and/or is otherwise accessible by mobile journal application software 26. For example, referring to FIG. 3, data stored in memory 24 may include mobile journal application software 26, event database 60, a call log 62, a text message log 64, a video/picture log 66, an MP3 log 68, a geographical location log 70, an environmental log 72, calendar data 74, contact log 76, voice memo log 78, etc. It will be appreciated that a wide variety of other types of data can be stored in the memory 24 as desired, and the types of data illustrated above are merely exemplary. One of ordinary skill in the art would appreciate that the data associated with the mobile journal application software 26 may be stored in any desired data structure and/or architecture.

The event database 60 generally maintains a chronological listing of all events and/or information that is accessible to the mobile telephone through use, geographical location, and/or environment information. An exemplary event database 60 is illustrated in FIG. 4. Referring to FIG. 4, the event database 60 includes a variety of fields. Such fields include, for example, EVENT NUMBER (#), DESCRIPTION, FROM, TO, DATE, TIME, ELAPSED TIME, GPS INFORMATION (also referred to as location information), ENVIRONMENT INFORMATION, MULTIMEDIA IDENTIFICATION, etc. One of ordinary skill in the art will readily appreciate that such fields are exemplary in nature and an application that falls within the scope of the claims appended hereto may include any desirable fields.

As shown in FIG. 4, the entries are organized by Event Number. The events are generally organized in rows, as shown in FIG. 4. The Event Identifier may be any desirable event description that relates to the user of the mobile telephone, location and/or environment in which the mobile telephone is present. Exemplary events may include, for example, calls and/or messages received, calls and/or messages initiated, photographs and/or videos, calendar information, contact information, location information, environment data, etc.

A variety of events are illustrated in FIG. 4. For example, Event #1 involved a telephone call received from Jane (who is in the user's contact list). If the caller was not in the user's contact list, the caller's telephone number or other suitable identifier could be used. The “To” field is blank because the call was to the user. The date and time is identified in the corresponding “Date” and “Time” fields. In addition, the elapsed time of the call is also provided, along with GPS location information, environment information (e.g., temperature, barometer readings, etc.) in corresponding fields. In addition, a multimedia identification may be provided that obtains titles and/or content of any audible background songs and/or videos that may be audible to the user of the mobile telephone.

Event #2 is a photograph taken by the user. The photograph is indexed in the database 60 with date and time information. In addition, GPS information, environment information and multimedia identification may also be recorded for the photograph. Event #3 is a doctor's appointment that was stored on the user's mobile telephone calendar. As shown, database 60 may record, the date and time of the appointment, the elapsed time of the appointment, GPS and environment information and multimedia identification, if desired. Event #4 illustrates an E-mail received from a contact (e.g., Tomas). The E-mail may include date and time information, as well as location and environment information and multimedia identification, if desired. Event #N is a SMS message sent from the user to Helen. The date and time of the message is recorded along any other desired information. One of ordinary skill in the art will readily appreciate that the above descriptions are exemplary in nature and not intended to limit the scope of the claims appended hereto.

While the above information may be stored in a database 60, this information may also be stored in the logs illustrated in FIG. 3. For example, the logs stored in the memory 24 can include information such as, the time in which the event began and/or occurred, the duration of the event, the number or person to whom or from whom a call or message is sent or received, the content of voice messages, text messages and/or emails, image and/or video data, temperature and/or elevation data, voice memo audio files, etc.

The events stored in memory 24 generally correspond to any and all usage of the mobile telephone 10 during a given time period. The events may also correspond to location of the mobile telephone and/or the environment in which the mobile telephone is used. A given time period may be any time period selected by a user. For example, depending on the user's needs, a given time period may be several hours, a single day, duration of a trip (e.g., a vacation) or any other time period of interest. The use of the mobile telephone 10 during the selected time period is usually highly indicative of the user's experience during the given time period. Accordingly, a wide variety of event types can be defined including alarms, tasks, appointments, text messages, playing of music files (MP3s), E-mails, incoming and outgoing calls, reminders, video mail messages, temperature readings, pictures/videos taken, web browser usage, mobile television usage, purchasing of content such as video games and/or music, signal status and/or strength, etc.

It will be appreciated that all of the log entries typically can include a variety of information. For example, the logs may include the date and time of the event, the duration of the event, the sender or recipient of the communication, the location of the phone at the time of the entry, etc. The location information can be specific or general depending on the degree of certainty to which the position of the mobile telephone 10 can be ascertained. The user may specify nicknames for certain locations, such as home, office, etc., so that the phone can identify the location in terms more familiar to the user. In addition, the use may download maps corresponding to the GPS location information associated with the event.

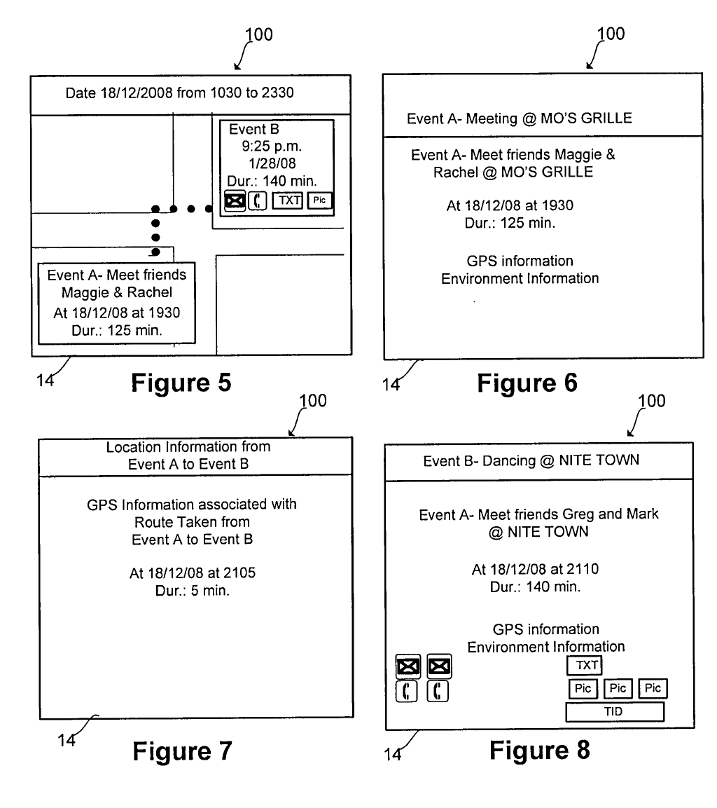

Referring to FIG. 5, and in accordance with an aspect of the invention, an exemplary slide show presentation 100 is illustrated for presenting the event information to the user. The slide show presentation 100 may include a plurality of events using events and/or event data stored in the memory 24 (e.g., in mobile journal application software 26). For example, FIG. 5 illustrates a number of events that occurred during a user selected period of interest (e.g., Dec. 18, 2008 from 1830 to 2330).

As shown in FIGS. 5-10, the slide show presentation 100 can be presented to the user via the display 14 in a graphical format. For example, a night out celebrating with friends could be recorded as follows. Event A occurs when the user meets with friends at a location identified in the calendar as MO'S GRILLE. The location may be determined by GPS information from the GPS 50. In addition, calendar information may be provided to explicitly identify the name of the location (e.g., MO'S GRILLE) and the names of invited friends (e.g., Maggie and Rachel), as shown in FIG. 5. Event information may also identify any music titles heard during the outing, the duration of the meeting and any other information gathered by the mobile telephone by the user's use of the mobile telephone.

As the user walks from Event A to another event, the route selected to traverse may be recorded through the GPS receiver 50. Such information may be provided in graphical format, as illustrated in FIG. 5, with a series of dots to illustrate the path traversed.

The user then arrives at Event B (e.g., dancing at the “NIGHT TIME” club) to meet up with other friends (e.g., Greg and Mark), as illustrated in FIG. 5. At Event B multiple pictures and/or videos may be taken to remember the night. Such photographs and/or video may include both group photographs and action photographs. Photographs and/or videos may be depicted with camera or photograph icons, as illustrated in FIG. 5. Each time a photograph and/or video is taken, information associated with a track of music playing in the background may be noted and logged in the mobile journal application software 26, as discussed above. In addition, location information, time and date information, elapsed time information, environment information, calendar and contact information may also be logged with respect to the photographs and/or videos.

During the course of the period of interest, the user may receive and/or send text messages to meet up or to simply chat with additional friends. The messages may be logged, music track information, location information, date and time information and/or environment information may also be recorded. Receipt and transmission of SMS message and E-Mails may also be depicted graphically as icons, as illustrated in FIG. 5.

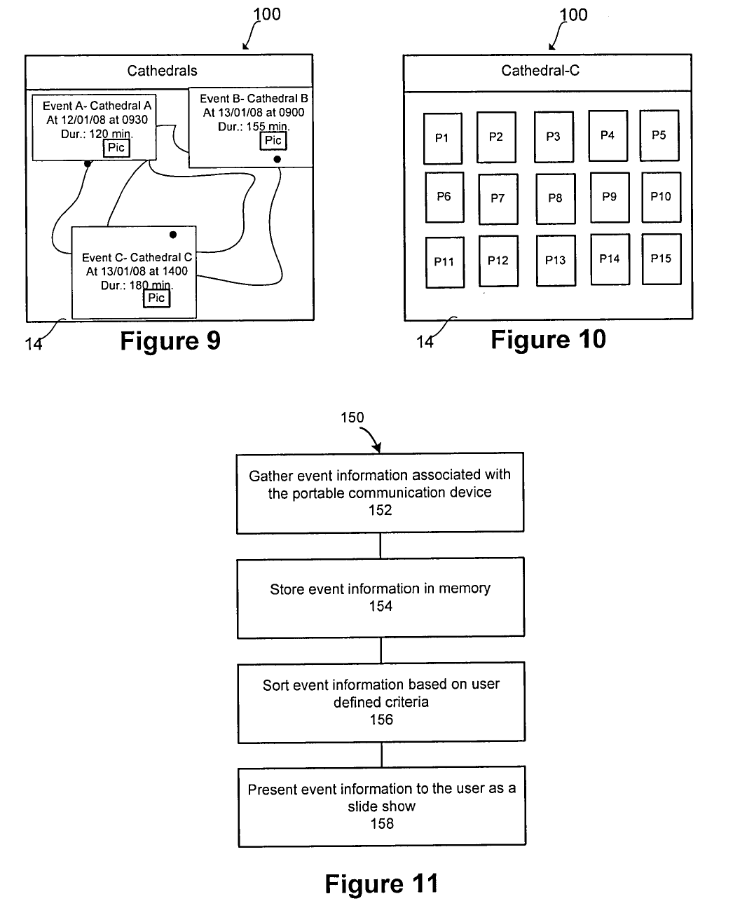

FIG. 5 illustrates a summary of the events that occurred during a date and time of interest. As stated above, it may desirable to represent the various events by a graphical representation that corresponds to elapsed time of an event. For example, large graphical representations indicate a longer time for the event than an event that has a smaller representation, as shown in FIGS. 5 and 9.

Referring back to FIG. 5, additional information related to a particular event may be provided when the user selects more detailed information. For example, when the user selects Event A, additional information related to Event A may be illustrated, as shown in FIG. 6. Referring to FIG. 6, the user is meeting with Maggie and Rachel at MO'S GRILLE. The GPS data associated with MO'S GRILLE and environment information may be provided. Music being played at MO'S GRILLE may also be tracked periodically throughout the user's visit, by the track identification function discussed above.

Referring to FIG. 7, GPS data is provided that illustrates the user traversing from Event A to Event B, when the user selects the route information, illustrated on FIG. 5.

Referring to FIG. 8, when the user selects Event B on FIG. 5, additional information regarding Event B is provided. Such information may include, the place (e.g., NITE TIME) and time (e.g. 2005-2330), GPS information, environment information, track identification information, photograph information, SMS information, and/or e-mail information. As shown in FIG. 8, thumbnails for each of the photographs (or a subset of the photographs) may be illustrated. When the user selects the thumbnail for the image, the entire image may then be displayed to the user. In addition, the complete text or a portion of a SMS message and/or E-mail may also be presented. In one embodiment, a portion of the message is provided and when the user selects the illustrated portion, the complete message is illustrated. Multiple icons may be displayed including multiple photographs, telephone calls, E-Mails, text messages, track identification information, etc.

The next day or at a later time, when the user is attempting to remember everything that happened during a busy night, the mobile journal application software 26 can generate a slide show containing pictures and full text message conversations. This slide show may be in chronological order, which contains a map of the night's destinations, and even a sound track pulled from the night's track identifications, assuming the user has the specific songs or chooses to download them. Then the user can download the file to a PC where it is already in a format ready for a scrap book or journal with just a few comments to add to the slide show, clip art to add to the SMS conversations or simply additional details to fill in the gaps.

Referring to FIG. 9, another use case is illustrated wherein a user is on vacation in Europe visiting cathedrals. In this case the background music may not be important but instead the location of the many pictures taken throughout the vacation is critical. In this case the user could choose to view the presentation on a map with clickable locations containing all the photographs taken in a particular city along with the day and time. For example, when the user selects Cathedral C, a thumbnail for each of the photographs taken at Cathedral C may be presented, as shown in FIG. 10. When the user selects a particular photograph, the entire photograph may be displayed to the user on the display 14.

Again, once this information collected in the mobile journal application software, the information may be downloaded to personal computer to edit and/or fill in any additional details needed. In this case since the city location information associated with the various cathedrals is so important there may be a server that the application accesses in order to collect highlight information about the town or attraction that could be made available to user. This would allow the user to incorporate this information into the user's mobile journal.

An exemplary method 150 for generating a mobile journal in accordance with aspects of the present invention is illustrated in FIG. 11. Referring to block 152, event information associated with use, location and/or environment of the portable communication device is gathered. Such event information is generally gathered through use of the telephone, active hardware on the mobile telephone, messages transmitted and/or received, etc. At block 154, the event information is generally stored in memory. The event information generally includes a date of the event, time event began, elapsed time of the event, event activity and location information associated with the event. At block 156, the event information may be sorted based upon a user defined criteria. For example, if the user is only interested in a particular event and/or series of events, only those events of interest may be selected. At block 158, the information selected is presented on a display to the user as a slide show. The slide show includes location information displayed in a map format along with event information including duration data displayed on the map for the user-specified time frame.

It will be appreciated that in any of the slides of the slide show, a wide variety of information can be displayed. For example, the time, the location, the event type, elapsed time and the temperature will typically be displayed if the information is available in memory 24. Other information such as the contents of messages, such as email and text messages may also be displayed. For example, FIG. 5, icons for photographs and SMS and E-Mail messages are displayed. When such icons are selected by the user additional information may be viewed. For example, each E-Mail message includes the name of the sender and the subject line of the message, along with the message. Similarly, SMS messages may be displayed indicating to or from whom the text message is directed and including the body of the text messages. FIG. 5 also includes a telephone icon that graphically depicts that a telephone call was made and/or received. The duration of each call may also be shown. The contents of the call may also be recorded and stored for later playback, if desired and assuming there is a suitable amount of memory storage available. It will be appreciated that if the user has assigned a photograph stored in the memory to a person to whom or from whom a call is placed or received, that person's picture may also be included in the scene.

It will be further appreciated that each slide of the slide show can be displayed for a desired length of time, for example, 5 seconds. The various slides generally correspond to events that occurred in chronological order during the time period that the mobile journal covers. The scenes can also be grouped together such that similar event types are shown in chronological order. For example, all of the text messaging events can be shown in order, followed by all of the call related events, and so on. Similarly, any photograph events may also be shown together and in order.

It will be appreciated that the slide show described can also include a wide variety of special effects and/or transitions between consecutive scenes. For example, a simple transition between consecutive slides would be a fade-out of one slide and a fade-in to the next slide. Similarly, a dissolve transition may be used. Another possibility would be for the clock to advance rapidly and continuously while the content of each slide changes corresponding to the various events that occur. Links to additional content, such as the full text of email and/or text messages can also be embedded in the slides so that a user can select the link to obtain the additional information.

As stated above, the slide show can include any and all information stored in memory 24, as desired. Alternatively, the user may select only certain event types and data to be included in the slide show. For example, the user may not want the content of messages to be displayed in the slide show. Accordingly, the user can designate that such information not be included in the slide show. Similarly, location information can be excluded from the slide show, for example.

It will be appreciated that a wide variety of templates can be provided for generating a slide show from the mobile journal application software. For example, various themes relating to places such as the beach, the mountains, the desert, etc. can be used. Such templates may include background art (e.g., beach ball, mountains, cactus, etc.) corresponding to the respective templates. Other templates relating to sports teams or life events such as graduations, weddings, anniversaries, birthdays, etc. can also be provided.

The slide show created from the mobile journal can be stored in any suitable file format, such as TIFF, PPT, JPEG, for example. In this regard, the slide show can be fully animated with transitions between various slides and the like, as discussed above.

Specific embodiments of the invention have been disclosed herein. One of ordinary skill in the art will readily recognize that the invention may have other applications in other environments. In fact, many embodiments and implementations are possible. The following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method for generating a mobile journal, the method comprising:
gathering event information associated with use of the portable communication device;
storing the event information in memory, wherein the event information includes a timestamp of the event, wherein the timestamp includes fields corresponding to a date of the event, time event began, elapsed time of the event, event activity and location information associated with the event;
sorting the information based upon a user defined criteria;
presenting the information on a display as a slide show, wherein the slide show includes location information displayed in a map format along with event information including duration data displayed on the map for a user-specified time frame.

2. The method of claim 1, wherein event information includes messages received by and transmitted from the portable communication device.

3. The method of claim 2, wherein event information includes one or more photographs and/or videos taken from the portable communication device.

4. The method of claim 3 further including obtaining track identification information associated with music and/or video audible during creation of the one or more photographs and/or videos.

5. The method of claim 3, wherein event information includes audio files rendered by the portable communication device.

6. The method of claim 5, wherein event information includes contact information, calendar information and/or schedule information stored in the memory of the portable communication device.

7. The method of claim 1 further including selecting event information to be included in the slide show, wherein the event information is selected based on one or more of the timestamp fields.

8. The method of claim 7, wherein the slide show includes graphical information regarding the location information associated with the selected event information.

9. The method of claim 8, wherein the slide show further includes graphical information regarding event duration data.

10. The method of claim 9 further including rendering at least one audio file while presenting the slide show.

11. The method of claim 1 further including downloading the slide show presentation to a computer for editing and/or presentation on the computer.

12. A portable communication device, the device comprising:
a display for presenting information to an associated user;
a memory for storing event information associated with use of the portable communication device, wherein the event information includes timestamp information that includes fields corresponding to a date event began, time event began, elapsed time of the event, event activity and location information associated with the use of the portable communication device;
application software stored in the memory and configured to generate a multimedia presentation of the event information stored in the memory, wherein the multimedia presentation includes geographic data displayed on a map and event data including duration data displayed on the map for a user-specified time frame; and
a controller coupled to the memory and responsive to the application software for presenting the multimedia presentation on the display as a slide show.

13. The device of claim 12, wherein event information includes messages received by and transmitted from the portable communication device.

14. The device of claim 13, wherein event information includes one or more photographs and/or videos taken from the portable communication device.

15. The device of claim 14, wherein event information includes music and/or video identification information audible when the one or more photographs and/or videos were created.

16. The device of claim 14, wherein event information includes audio files rendered by the portable communication device.

17. The method of claim 16, wherein the slide show includes graphical information regarding location information.

18. The method of claim 17, wherein the slide show further includes graphical information regarding event duration data.

19. The portable communication device of claim 1, wherein the device is a mobile telephone.

20. A computer program stored on a machine readable medium, the program being suitable for use in a portable communication device as a mobile journal application, wherein:
when the program is loaded in memory in the portable communication device and executed causes the portable communication device to:
gather event information associated with use of the portable communication device;
store the event information in a memory of the portable communication device, wherein the event information includes a timestamp of the event, wherein the timestamp includes fields corresponding to a date of the event, time event began, elapsed time of the event, event activity and location information associated with the event;
sort the information based upon a user defined criteria; and
present the information on a display of the portable communication device as a slide show, wherein the slide show includes location information displayed in a map format along with event information including duration data displayed on the map for a user-specified time frame.
